(19) United States
(12) Patent Application Publication
(10) Pub. No.: US 2019/0185087 A1
(43) Pub. Date: Jun. 20, 2019

(54) Detachable Service Jack Adapter for Mounting Vehicular Spindles

(71) Applicants: Bosch Automotive Service Solutions Inc., Warren, MI (US); Robert Bosch GmbH, Stuttgart (DE)

(72) Inventors: Marcelo Alves de Moraes, Burnsville, MN (US); Robert Kochie, Dodge City, MN (US); Larry Lageson, Ellendale, MN (US)

(21) Appl. No.: 16/204,885

(22) Filed: Nov. 29, 2018

Related U.S. Application Data
(60) Provisional application No. 62/608,228, filed on Dec. 20, 2017.

(51) Int. Cl. B62D 65/12; F16M 13/02; B25H 1/00; B66F 5/04

(52) U.S. Cl. CPC B62D 65/12; B66F 5/04; B25H 1/0042; F16M 13/02

(57) ABSTRACT

An adapter bracket operable to detachably mount to the seat of a vehicular jack, permitting the vehicular jack to support an automotive spindle during servicing. The adapter bracket may comprise a mounting mechanism operable to detachably mount to a wide variety of seat configurations. The adapter bracket may comprise an adjustable arm assembly operable to support spindles having a wide variety of stud configurations.

### TECHNICAL FIELD

This disclosure relates to specialty tools for use in automotive repair services.

### BACKGROUND

Automotive spindles are used to operably attach a wheel assembly to the rest of the automobile, typically to the axle or suspension of the automobile. Corrosion, wear, and damage to the spindle may render a vehicle inoperable, and thus repair and maintenance of spindles can be a critical factor in the operating lifespan of an automotive vehicle.

Because spindles are typically bearing a heavy load of the vehicle in normal operation, repair and maintenance is often performed from underneath the vehicle. This position may be ergonomically undesirable, because it requires the technician to perform the tasks in a suboptimal position that may provide inconvenient access to tools or workbench functions. Alternatively, technicians may employ specialized tools to remove the spindle from the vehicle, but such tools are typically bulk and very expensive, and will often only be compatible with a small range of spindle configurations.

It is therefore desirable to provide an inexpensive, efficient tool that is operable to remove a spindle from a vehicle for repair or maintenance.

### SUMMARY

One aspect of this disclosure is directed to a bracket configured to be detachably mounted upon a vehicular jack that is further operable to securely support an automotive spindle for repair or maintenance, including when the spindle is detached from the automobile. The bracket may comprise a mounting surface operable to mount the bracket to the vehicular jack, and an interface surface operable to securely support the spindle using a number of adapter arms operable to receive studs of the spindle.

Another aspect of this disclosure is directed to a vehicular jack having an adapter bracket detachably coupled thereto, the adapter bracket being operable to securely support an automotive spindle using the vehicular jack. Secure support of the vehicular spindle may be accomplished using an adapter arm having a stud washer that is operable to interact with a variety of spindles having, a variety of configurations.

A further aspect of this disclosure is directed to a bracket configured to be detachably mounted upon a vehicular jack, the bracket further operable to securely support an automotive spindle. Support for the automotive spindle may be accomplished via a pair of adapter arms each having a spindle washer this is adjustable to be compatible with a variety of spindles having a variety of configurations. Detachable mounting to a vehicular jack may be accomplished via a number of mounting bolts inserted through a number of mounting slots in a mounting surface of the bracket, the mounting slots operable to be compatible with a variety of vehicular jacks having a variety of mounting configurations.

The above aspects of this disclosure and other aspects will be explained in greater detail below with reference to the attached drawings.

### BRIEF DESCRIPTION OF THE DRAWINGS

FIG. 1 is an illustration of an adapter bracket configured to permit a vehicular jack to support an automotive spindle.

FIG. 2 is a diagrammatic illustration of a vehicular spindle secured to an adapter bracket.

FIG. 3 is an illustration of a vehicular jack mounted with an adapter bracket and operably supporting an automotive spindle.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

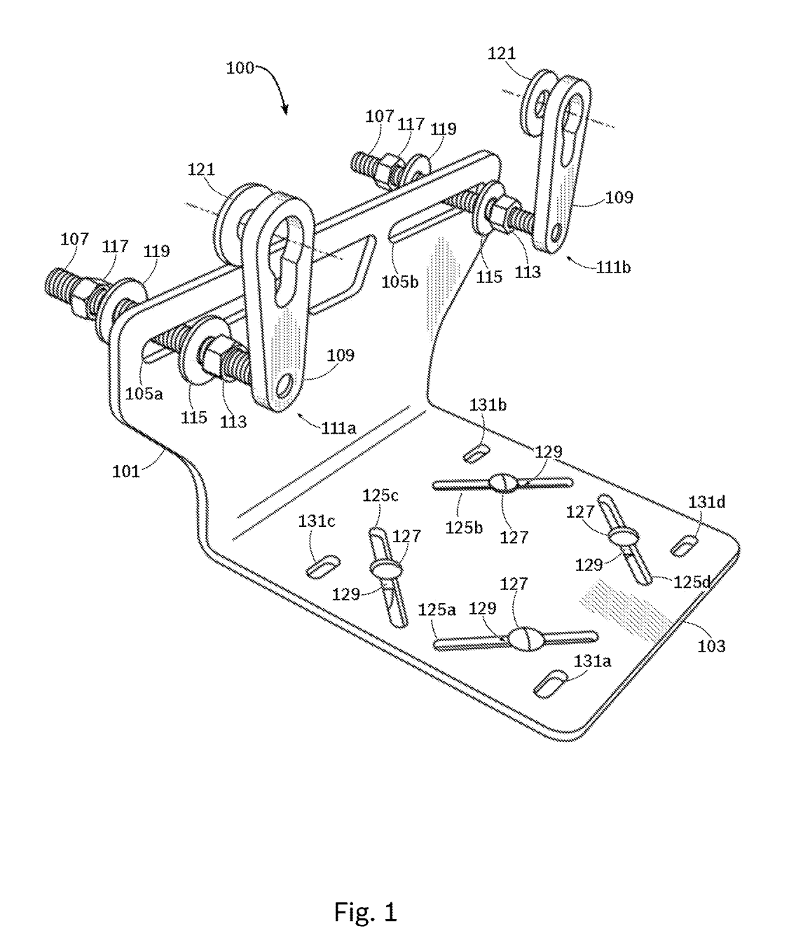

FIG. 1 is a depiction of an adapter bracket 100 suitable for mounting onto a vehicular jack that is operable to support a spindle of an automobile. Bracket 100 comprises an L-shape comprised of an interface surface 101 and a mounting surface 103. Interface surface 101 and mounting surface 103 form a substantially perpendicular angle to form the L-shape of bracket 100. Throughout this disclosure, “substantially perpendicular” refers to an angle that is 90-degrees within tolerances designated by manufacturing requirements or by factors known to one of ordinary skill in the art. In the depicted embodiment, the substantially perpendicular angle may be 90-degrees within a 10-degree tolerance. This exemplary tolerance is given by way of example and not limitation. Other embodiments may comprise other tolerances without deviating from the teachings disclosed herein.

Within interface surface 101 are a number of arm slots 105, having a linearly-extended shape extending in a direction that is substantially parallel to the mounting surface 103. Throughout this disclosure, “substantially parallel” refers to an angle that is 0-degrees within tolerances designated by manufacturing requirements or by factors known to one of ordinary skill in the art. In the depicted embodiment, the substantially parallel angle may be 0-degrees within a 10-degree tolerance. This exemplary tolerance is given by way of example and not limitation. Other embodiments may comprise other tolerances without deviating from the teachings disclosed herein.

In the depicted embodiment, a pair of arm slots 105 are each formed along the edge of interface surface 101 furthest from mounting surface 103, but other embodiments may comprise a different number of arm slots 105, or a different placement of arm slots 105 with respect to bracket 100 without deviating from the teachings disclosed herein.

Each of arm slots 105 may be operable to receive an adapter arm 107. Adapter arm 107 comprises a threaded cylindrical rod having a diameter sized such that the adapter arm 107 may be inserted within an arm slot 105 without engaging the threads of the adapter arm 107. A stud washer 109 is coupled to adapter arm 107 at the end closest to mounting plate 103 when adapter arm 107 is inserted into arm slot 105, forming an arm assembly 111. Stud washer 109 may receive the stud of an automotive spindle. Stud washer 109 may rotate about an axis defined by adapter arm 107. Arm assembly 111 may be displaced along the length of arm slot 105, and may also be positioned within arm slot 105 along a direction substantially perpendicular to interface surface 101. The adaptable position of arm assembly 111 may permit stud washer 109 to receive a stud from a variety of spindles having a variety of configurations. In the depicted embodiment, stud washer 109 may be configured such that it is operable to receive a variety of studs having different diameters and geometric designs, but other embodiments may comprise other configurations without deviating, from the teachings disclosed herein.

The depicted embodiment comprises a pair of arm assemblies 111, each having an adapter arm 107 and a stud washer 109, but other embodiments may comprise a different number of arm assemblies 111 without deviating from the teachings disclosed herein.

Because an arm assembly 111 may be positioned freely within an arm slot 105, a positioning nut 113 may engage adapter arm 105 between interface surface 101 and stud washer 109. Positioning nut 113 may be positioned at a particular point along the linear length of adapter arm 105 to define the minimum distance between stud washer 109 and interface surface 101. The desired minimum distance is determined by the specification of the spindle to be mounted upon the bracket 100. A positioning washer 115 may be utilized to distribute the load of positioning nut 113.

Positioning nut 113 may be operable to define a minimum distance between stud washer 109 and interface surface 101. A locking nut 117 may engage adapter arm 105 on the opposite side of interface surface 101 from positioning nut 413 to define a maximum distance between stud washer 109 and interface surface 101. The desired maximum distance is determined by the specification of the spindle to be mounted upon the bracket 100. A locking washer 119 may be utilized to distribute the load of locking nut 117.

Positioning nut 113 and locking nut 117 may be utilized in tandem to set of position of arm assembly 111 with respect to interface surface 101 such that stud washer 109 is effectively at a fixed distance from interface surface 101. The desired fixed distance from interface surface 101 is determined by the specification of the spindle to be mounted upon the bracket 100. The utilization of the desired fixed distance may be operable to create stable support for the spindle by bracket 100. The stability of the support may further be optimized by utilizing lug nuts from the spindle (not shown) to couple the spindle to the bracket 100. In the depicted embodiment, bracket 100 includes a lug washer 121 to distribute the load of a lug nut. The depicted embodiment comprises a pair of arm assemblies 111, each having an associated positioning nut 113, positioning washer 115, locking nut 117, locking washer 119, and lug washer 121, but other embodiments may comprise other configurations having a different number of each of these components without deviating from the teachings disclosed herein.

Mounting surface 103 comprises a mounting mechanism operable to couple bracket 100 to the seat of a vehicular jack. The mounting mechanism may comprise a number of first mounting slots 125 having a linearly-extended shape and disposed at a substantially 45-degree angle with respect to the edges of mounting surface 103. Throughout this disclosure, “substantially 45-degree” refers to an angle that is 45-degrees within tolerances designated by manufacturing requirements or by factors known to one of ordinary skill in the art. In the depicted embodiment, the substantially parallel angle may be 0-degrees within a 10-degree tolerance. This exemplary tolerance is given by way of example and not limitation. Other embodiments may comprise other tolerances without deviating from the teachings disclosed herein.

In the depicted embodiment, the first mounting slots 125 are arranged in two substantially parallel pairs, each pair arranged such that its respective members are substantially perpendicular to the first mounting slots of the other pair. Other embodiments may comprise other configurations having a different number or a different arrangement of first mounting slots 125 without deviating from the teachings disclosed herein. Each of first mounting slots 125 may be coupled to a mounting bolt 127, and the arrangement of first mounting slots 125 may advantageously provide a wide variety of placement of a mounting bolt 127 with respect to mounting surface 103. The wide variety of placements for a mounting bolt 127 may improve the compatibility of bracket 100 with a variety of vehicular jacks. In the depicted embodiment, mounting bolts 127 may engage a mounting nut 129 disposed on the opposite side of mounting surface 103. Some embodiments may not comprise mounting nuts 129, and instead mounting bolts 127 may engage directly with threaded slots or nuts affixed to the seat of the associated vehicular jack. In the depicted embodiment, bracket 100 comprises a set of four mounting bolts 127 and four respective mounting nuts 129, but other embodiments may different numbers of mounting bolts 127 and respective mounting nuts 129.

Mounting surface 103 may further comprise a second set of mounting slots 131. Second mounting slots 131 comprise oblong slots formed in mounting surface 103 that are sufficiently sized to receive a mounting bolt 127. In the depicted embodiment, bracket 100 comprises four mounting bolts 127 to be inserted into any of the first mounting slots 125 or second mounting slots 131, but other embodiments may comprise a different number of mounting bolts 127. Second mounting slots 131 may advantageously improve the compatibility of bracket 100 with a variety of vehicular jacks. Some embodiments may comprise only one of first mounting slots 125 and second mounting slots 131 without deviating from the teachings disclosed herein.

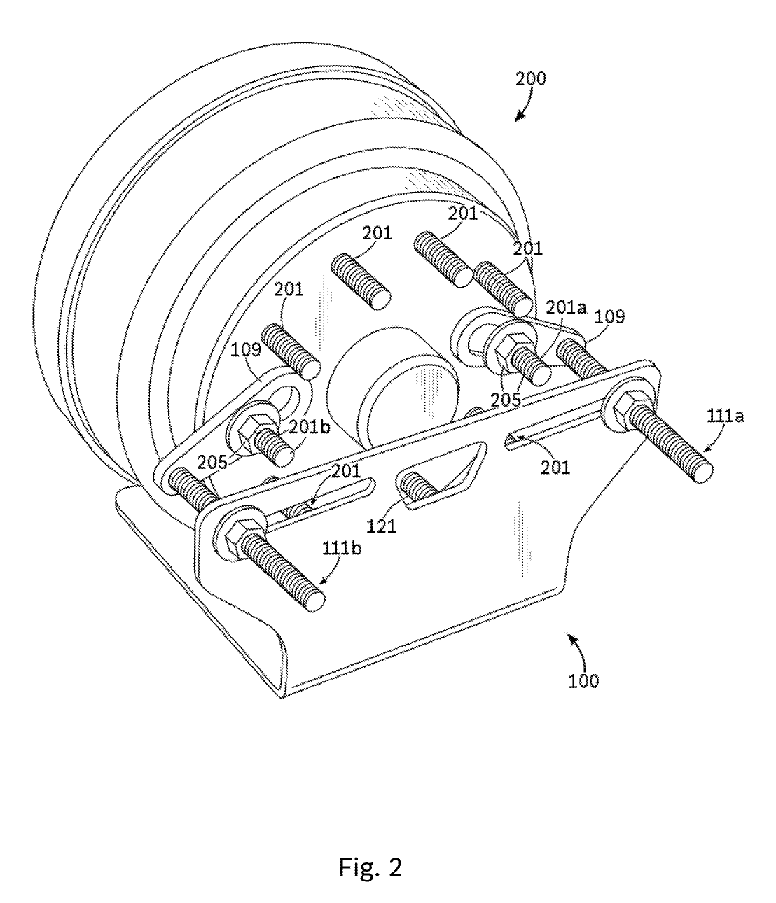

FIG. 2 is an illustration of bracket 100 when configured to support a spindle 200. Spindle 200 comprises a number of functionally identical studs 201, each of the studs disposed in a regular symmetrical pattern around the face of spindle 200. The arm assemblies 111 of bracket 100 have been configured such that stud washers 109 have accepted one of studs 201, and are secured with a lug nut 205. In the depicted embodiment, a lug washer 121 may be utilized to distribute the load of its respective lug nut 205. In the depicted embodiment, stud 201a and stud 201b are functionally identical to the rest of studs 201, but are given special designation to illustrate that they have been received by one of stud washers 109. Stud 201a and stud 201b are further distinguished in practice only by where they are disposed upon spindle 200. Because spindle 200 exhibits substantial radial symmetry, the particular orientation of the studs 201 may only be relevant when one or more of studs 201 requires repair or maintenance.

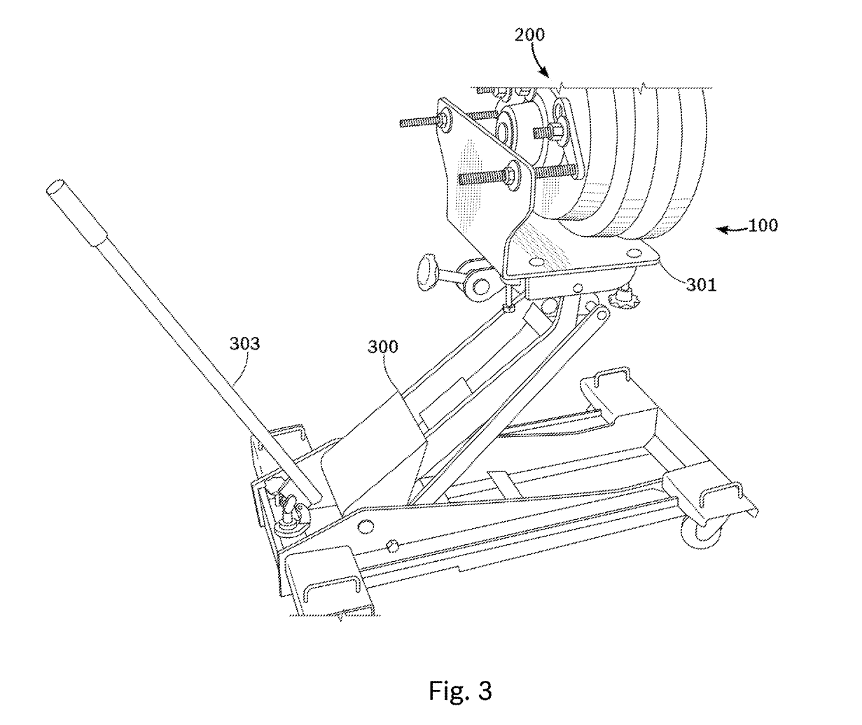

FIG. 3 is an illustration of a vehicular jack 300 having a seat 301 operable to lift the frame of a vehicle. Seat 301 may comprise an attachment mechanism to which bracket 100 may be detachably coupled using a mounting mechanism (see FIG. 1). In the depicted embodiment, vehicular jack 300 is depicted with a spindle 200 (see FIG. 2) already supported by the bracket 100, however, embodiments wherein the vehicular jack 300 has been coupled to bracket 100 before supporting a spindle 200 do not deviate from the teachings disclosed herein.

In the depicted embodiment, vehicular jack 300 comprises a hydraulic lifting mechanism actuated by a lever 303, but other embodiments may utilize any other known configuration of a vehicular jack 300 having a seat 301 without deviating from the teachings disclosed herein. The maximum load of the vehicular jack 300 may be specified by the vehicular requiring service without deviating from the teachings disclosed herein. In the depicted embodiment, the maximum load of the vehicular jack 300 and bracket 100 may be 350 pounds, but other embodiments may comprise other configurations without deviating from the teachings disclosed herein.

In one embodiment, bracket 100 may be detachably coupled to seat 301 of vehicular jack 300. Advantageously, detachable coupling of bracket 100 may provide for flexible utility of the vehicular jack 300 in situations wherein a spindle 200 requires service. The vehicular jack 300 may first be used without the bracket 100 to raise the vehicle by the frame near the wheel requiring service. Once the vehicle has been lifted to an appropriate height, a vehicle stand (not shown) may be placed under the frame of the vehicle, and vehicular jack 300 may be removed from under the vehicle. Vehicular jack 300 may then be detachably coupled to bracket 100 such that it is operable to support a spindle 200 in need of repair. The wheel assembly of the associated spindle 200 may be removed to expose the spindle 200. Spindle 200 may be supported by bracket 100 and vehicular jack 300, permitting spindle 200 to be decoupled from the vehicle for repairs. Advantageously, the bracket 100 may permit vehicular jack 300 to be operable to perform additional functions that may otherwise require expensive specialized tools. In this embodiment, service of spindle 200 may be advantageously performed at a technician's work bench, with easy access to tools and better ergonomic conditions for the technician such as lighting and posture. After service is complete, the repaired spindle 200 may be re-coupled to the vehicle, the wheel assembly of the associated spindle 200 may be re-attached, bracket 100 may be detached from seat 301, and the vehicular jack 300 may be replaced under the frame of the vehicle. Once vehicular jack 300 has been replaced under the frame of the vehicle and supporting the load of the vehicle, the vehicle stand may be removed, and the vehicular jack 300 may be utilized to lower the vehicle to the supporting surface of the jack (e.g., the workshop floor or the ground).

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A vehicular spindle frame comprising:
a bracket having a mounting surface and an interface surface, the mounting surface and the interface surface forming a substantially perpendicular angle, the interface surface having an arm-slot and the mounting surface comprising a mounting mechanism configured to mount the bracket onto a service jack;
an adapter arm, the adapter arm operable to be inserted through the arm-slot and operable to be positioned within the arm slot along a direction substantially perpendicular to the interface surface;
a positioning nut operable to engage the adapter arm and operable to set a position of the adapter arm in a direction substantially perpendicular to the interface surface when the adapter arm is inserted through the arm-slot; and
a stud washer coupled to the adapter arm such that the adapter arm defines an axis about which the stud washer may rotate, the stud washer operable to receive a stud of a vehicular spindle.

2. The vehicular spindle frame of claim 1, comprising a locking nut operable to engage the adaptor arm and cooperate with the positioning nut to set a position of the adapter arm relative to the interface surface.

3. The vehicular spindle frame of claim 1, wherein the stud washer is operable to receive a variety of studs having a variety of configurations.

4. The vehicular spindle frame of claim 1, wherein the mounting mechanism comprises a mounting slot and a mounting bolt operable to be threaded through mounting slot.

5. The vehicular spindle frame of claim 1, wherein the number of mounting slots comprises a number of linearly-extended slots each arranged at a 45-degree angle with respect to the edges of the mounting surface.

6. A vehicular jack assembly comprising:
a lifting mechanism having a seat and operable to provide an upward force upon the seat in a direction away from a support surface;
an angled bracket detachably coupled to the saddle, the angled-bracket having a mounting surface and an interface surface disposed in a substantially perpendicular angle wherein the interface surface comprises a number of arm-slots and wherein the angled bracket is operable to support a vehicular wheel spindle;
an adapter arm inserted through the arm-slot, and operable to be positioned within the arm-slot along a direction substantially perpendicular to the interface surface;
a positioning nut operable to engage the adapter arm and to set a position of the adapter arm in a substantially perpendicular direction to the interface surface when the adapter arm is inserted into the arm-slot; and
a stud washer coupled to the adapter arm such that the adapter arm defines an axis through the stud washer about which the stud washer may rotate, the stud washer operable to receive a stud of a vehicular spindle.

7. The vehicular jack assembly of claim 6, wherein the lifting mechanism further comprises a hydraulic jack mechanism to provide the upward force to the seat.

8. The vehicular jack assembly of claim 7, wherein the hydraulic jack mechanism is operable to support the weight of a vehicular spindle.

9. The vehicular jack assembly of claim 7, wherein the hydraulic jack mechanism is operable to support a weight of 350 pounds.

10. A vehicular spindle frame comprising:
an L-bracket having a mounting surface and an interface surface, the mounting surface and the interface surface disposed in a substantially perpendicular angle;
a pair of arm-slots disposed within the second interface surface, the arm-slots having a linearly-extended form and disposed symmetrically from the edges of the second interface surface in an orientation that is substantially parallel to the first mounting surface;
a pair of adapter arms, each of the adapter arms inserted into one of the arm-slots, the adapter arms operable to freely slide along the linear length of its respective arm-slot and further operable to be positioned along a direction that is substantially perpendicular to the second interface surface and substantially parallel to the first mounting surface;
a pair of positioning nuts for each of the pair of adapter arms, the positioning nuts operable to engage an adapter arm to set a position of the adapter arm along the direction substantially perpendicular to the second interface surface when the adapter arm is inserted into an arm-slot; and
a pair of stud washers, each stud washer coupled to one of the adapter arms such that the adapter arm defines an axis about which the stud washer may rotate, wherein each stud washer is operable to receive a stud of a wheel spindle.

11. The vehicular spindle frame of claim 10, further comprising a pair of locking nuts, each locking nut operable to engage an adaptor arm and cooperate with a respective positioning nut to set a position of the adapter arm relative to the interface surface.

12. The vehicular spindle frame of claim 10, wherein the mounting surface comprises a first set of mounting slots having a linearly-extended shape and disposed within the mounting surface, each of the first set of mounting slots oriented linearly in a direction substantially at a 45-degree angle to the interface surface, the first set of mounting slots comprising a first pair of first mounting slots disposed in a substantially parallel orientation and a second pair of first mounting slots in a substantially parallel orientation that is substantially perpendicular to the orientation of the first pair of first mounting slots.

13. The vehicular spindle frame of claim 12, wherein the mounting surface comprises a second set of mounting slots disposed within the mounting surface, each of the second set of mounting slots comprising an oblong shape oriented such that it is substantially parallel to the interface surface and substantially at a 45-degree to the orientation of each of the first set of mounting slots, each of the second set of mounting slots disposed between at least one edge of the first mounting surface and one of the first set of mounting slots.
